(19) United States
(12) Patent Application Publication
(10) Pub. No.: US 2015/0095204 A1
(43) Pub. Date: Apr. 2, 2015

(54) Processes and Systems for Recovering Refundable Taxes

(71) Applicant: MASTERCARD INTERNATIONAL INCORPORATED, Purchase, NY (US)

(72) Inventor: Matthew Hanmer, Northampton (GB)

(21) Appl. No.: 14/500,578

(22) Filed: Sep. 29, 2014

(30) Foreign Application Priority Data
Sep. 30, 2013 (GB) 1317312.5

(51) Int. Cl. G06Q 40/00

(52) U.S. Cl. CPC G06Q 40/123
USPC 705/31

(57) ABSTRACT

The present disclosure relates to systems for recovering refundable taxes. The system includes a claims interface processor for an electronic device. The claims interface processor comprises; a tax refund application for allowing a user/cardholder to apply for a tax refund based on prior product purchases; a communication module arranged to send the tax refund application to a tax refund processor and receive a tax refund approval or rejection, the tax refund approval or rejection based on a risk score relating to the tax refund application; wherein the communication module is also arranged to send a tax refund instruction to an acquirer in response to receiving the tax refund approval.

### FIELD

The present disclosure relates in general to electronic transactions carried out within the context of a financial authorization, clearing and settlement system. More specifically, the disclosure relates to a processes and systems for handling the recovery of refundable taxes that have been levied during such electronic transactions for the payment of goods and services.

### BACKGROUND

A feature that is common to the retail industry world-wide is the imposition of a sales tax or value added tax (known as VAT) to the purchases of various goods and services. Such taxes are applied for a variety of reasons such as to discourage or promote spending on certain goods categories, and serve as a significant revenue generator for a respective government. The United Kingdom (UK), for example, imposes a 20% VAT on many categories of goods and services that are purchased.

In some countries, however, some of these taxes are refundable to non-resident visitors under certain conditions. Staying with the UK by way of example, the ‘VAT Retail Export Scheme’ permits non-European (EU) residents visiting the UK to recover VAT on goods they buy for personal export outside the UK. The Retail Export Scheme thus contributes to the UK economy by encouraging overseas visitors to buy goods when they visit the UK since the effective cost of those goods is reduced. The UK-wide scheme ensures that goods are taxed only where they are used and prevents ‘double taxation’, which could otherwise occur if goods were taxed in the UK when they are purchased and again in the visitor's home country when imported.

Currently, the process of obtaining a VAT refund on purchases is largely paper-based. In a typical process, when an overseas visitor visits a shop or ‘merchant’ in the UK and wishes to obtain a refund of the VAT levied on the transaction, the retailer and the customer complete a tax recovery document (e.g. HMRC official form VAT407) with details of the transaction. A prerequisite of this, however, is that the retailer participates on the VAT Retail Export Scheme, usually identified by the ‘Tax Free Shopping’ sign.

When leaving the UK, the visitor is required to present the tax recovery document and the goods at UK customs at their point of departure from the UK for inspection and validation by a customs official. Once the tax recovery document has been approved by customs, the tax recovery document may be sent to the retailer who will then refund the visitor and ‘zero-rate’ the transaction in the business accounts. Some retailers pay the refund directly, but others may choose to operate through a third party refund company. Alternatively some retailers may have arrangements with a refund booth at UK departure ports, and perhaps other locations such as shopping malls, which provide visitors with the facility to obtain refunds before leaving the country. Note that other EU countries have similar Retail Export Schemes in place and similar processes exist for many non-EU countries.

As will be appreciated by the above discussion, the process is by-and-large a manual one and requires engagement between retailers and customers to fill in documentation which reduces the effectiveness of the process, reduces take-up and, ultimately, may discourage overseas visitors from spending on big-ticket items in the home country. Thus, there is a need to increase the efficiency of the process.

One proposal is described in U.S. Pat. No. 6,546,373 (B1) in which purchases subject to VAT (or sales tax) made by a traveller are recorded on an electronic transaction card that is loaded with a dedicated application able to recorded the relevant purchases. During the travellers visit to a foreign country, the electronic transaction card records the purchases made and accumulates the refundable tax amount. When the traveller leaves the country, the electronic transaction card may be inserted into a suitable terminal which reads the purchase information and manages a tax refund application process including communicating with a suitable taxing authority and tax recover application supplier if appropriate. The traveller may be issued with a tax refund for eligible purchases there and then at the terminal.

### SUMMARY

According to an aspect of the present disclosure there is provided a claims interface processor for an electronic device, comprising: a tax refund application for allowing a user/cardholder to apply for a tax refund based on prior product purchases; a communication module arranged to send the tax refund application to a tax refund processor and receive a tax refund approval or rejection, the tax refund approval or rejection based on a risk score relating to the tax refund application; wherein the communication module is also arranged to send a tax refund instruction to a merchant in response to receiving the tax refund approval.

The claims interface processor allows for retroactive tax refund applications to be made by a user/cardholder using a paperless single interface. There is also no need for additional hardware, for example, a bespoke card to be created since data relating to purchases and the user/cardholder is stored electronically and the refund is performed by the interface processor.

The communication module may be arranged to receive the risk score from the tax refund processor in response to sending the tax refund application and wherein the communication module may be further arranged to send the risk score to a tax refund authority in response to receiving the risk score and receive the approval or rejection from the tax refund authority.

The claims interface processor may comprise a registration module for allowing a user/cardholder to register a card for making product purchases.

The claims interface processor may be internet based for communicating with the tax refund processor and the tax authority remotely.

The claims interface processor may further comprise a secure login module arranged to allow a user/card holder to login in securely.

The claims interface processor may be arranged to provide a notification to the user/cardholder that the tax refund application has been approved or declined in response to receiving the tax refund approval or rejection.

According to a further aspect of the present disclosure there is provided a tax refund processor comprising: a risk scoring engine arranged to monitor a transaction made by a user/cardholder and to provide a risk score associated with refunding a tax of the transaction; and an interface module arranged to receive a tax refund application from a claims interface processor as described hereinabove and output the risk score in response.

Risk profiling aids in reducing the threat of fraudulent claims associated with the purchases goods/services.

The risk score may be returned to the claims interface processor.

The risk score may be determined based on a risk associated with the user/cardholder and a risk associated with a merchant involved in the transaction.

The risk associated with the user/cardholder may be based on data relating to payment transactions made by the user/cardholder and data relating to user/cardholder registration.

The data relating to the payment transactions may include at least one of frequency of use, stores, country of use, and category of good/services purchased.

The data relating to user/cardholder registration may include at least one of passport details and address.

The risk associated with a merchant involved in the transaction may be based on merchant payment data recorded by the tax refund processor and merchant registration data provided by a merchant upon registration.

The merchant payment data may include at least one of a Merchant Identification Number (MID) and a Merchant Category Code (MCC).

According to a further aspect of the present disclosure there is provided a merchant accounting platform comprising: a monitoring module for monitoring tax paid on purchases of goods/services; a communication module arranged to communicate with a claims interface processor as described hereinabove for receiving the tax refund instruction; and a payment module arranged to instruct a merchant to pay monies to a user/cardholder based on the tax refund instruction.

The merchant accounting platform may further comprise a registration interface for registering details relating to a merchant involved in the transaction.

According to a further aspect of the present disclosure there is provided a tax authority comprising: a communications module arranged to receive and send messages to/from a claims interface processor as described hereinabove; a comparator arranged to compare the risk score to a predetermined threshold risk value and return a rejection or approval of the tax refund application in response to the risk score being lower than the predetermined threshold risk value.

The disclosure may also be expressed as a computer implementable process or method that is executable on a suitable computing device to perform any of the steps or functional features of the aspects of the present disclosure as defined above.

### DRAWINGS

In order that the present disclosure may be more readily understood, reference will now be made, by way of example, to the accompanying drawings in which:

FIG. 1 is a block diagram illustrating a financial payment transaction and entities involves with an electronic tax refund process;

FIG. 2 is a flowchart showing an embodiment of an electronic tax refund process;

FIG. 3 is a flow chart of a sub-process implemented within the process in FIG. 2;

FIG. 4 is a flow chart of a further sub-process implemented within the process of FIG. 3; and

FIG. 5 is a flow chart of a sub-process implemented within the sub-processes of FIGS. 3 and 4.

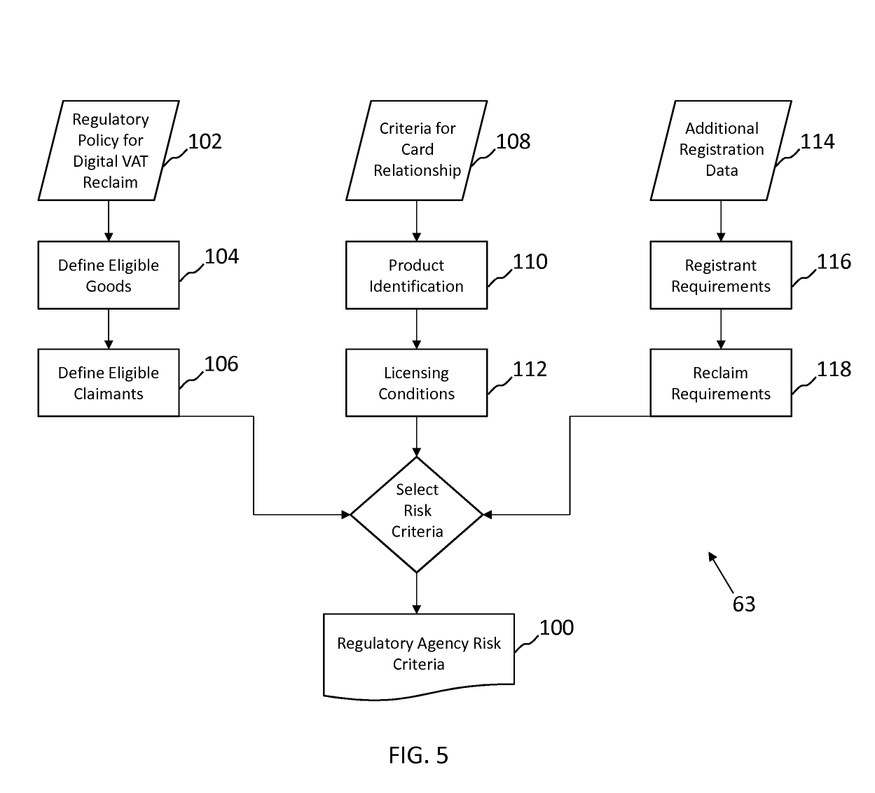

### DETAILED DESCRIPTION

The process will be described in the context of VAT regime currently operating in the UK, although the skilled person will appreciated that the disclosure is also applicable to other ‘sales tax’ regimes in other countries.

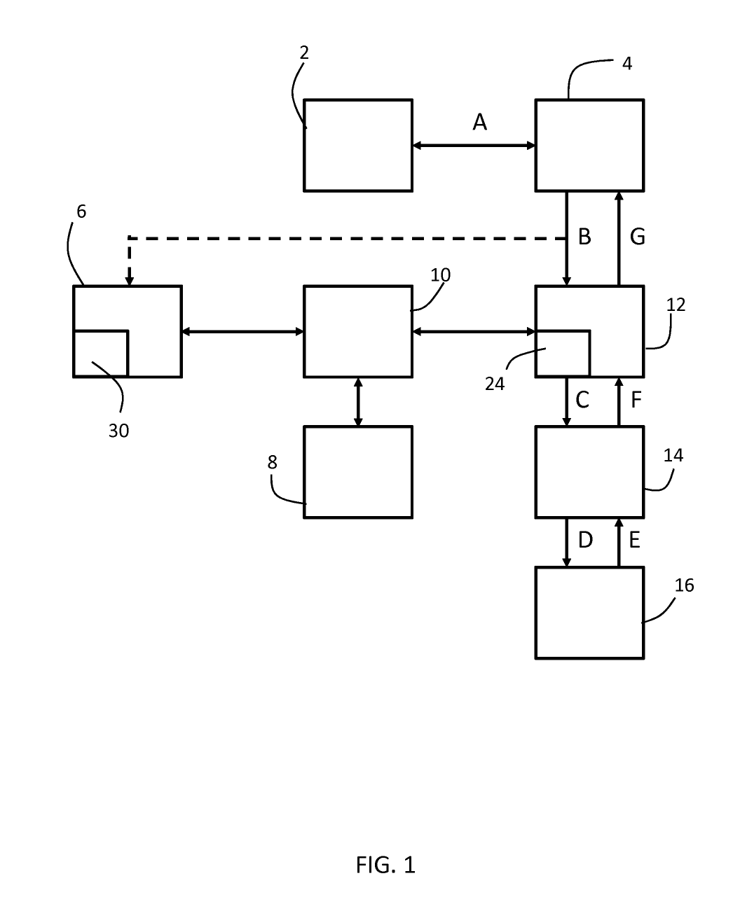

FIG. 1 illustrates a block diagram of a financial transaction between a user/cardholder 2 and a merchant 4. FIG. 1 also illustrates the participating entities in a process by which the user/cardholder may apply to claim back the tax (in this case, VAT) on the amount of the transaction. In overview, these participating entities are a tax refund processor 6 and a tax authority 8. In the UK context, the service of the tax refund processor 6 may be provided by a payments processor such as Visa® or MasterCard®, and the tax authority is HMRC. A claims interface or ‘platform’ 10 communicates with the tax refund processor 6. The claims interface 10 is an electronic personal computing device such as a PC, a tablet computer, and the like which is loaded with a communications module to communicate with the tax refund processor 6, as will be described later.

The financial transaction may typically be a payment transaction for the purchase of goods/services in which the merchant 4 communicates with a financial transaction network for authorization for the payment prior to later completion of the transaction by way of a clearance and settlement process. Since the tax refund process relates to the claiming back of goods purchased in the UK, it is envisaged that the financial transaction will relate to transactions originating in physical ‘bricks and mortar’ establishments to minimize fraud opportunities as opposed to online ‘cardholder not present’ payments which may be originated at locations outside of the UK.

The process begins by the initiation of a financial transaction by a user/cardholder device 2 communicating with the merchant 4 as indicated by arrow ‘A’ in order to pay for goods and services by way of a suitable device such as a chip and pin card reader. Accordingly, the transaction may be conducted under the EMV (Europay Mastercard Visa) standard, as is known in the art.

The merchant 4 then constructs a payment transaction and communicates with an acquirer 12 (or ‘merchant's bank’) via a dial-up line, for example, in order to obtain an authorization for the payment that the user wishes to make, as indicated by arrow ‘B’. In response, the acquirer 12 then communicates the transaction to the transaction processing entity 14 (or ‘transaction processor’), as illustrated by arrow ‘C’. The acquirer 12 is also communicable with the claims interface processor 10 by virtue of the claims communications module thereof.

At this point the transaction processor 14 is required to communicate (arrow D) with an issuer 16 (or ‘cardholder's bank’) of the card in question after it has carried out appropriate validation and security checks on the card. The issuer 16 then carries out necessary credit worthiness checks to ensure that the account balance of the cardholder is sufficient to cover the payment amount and fraudulent activity checks and communicates a response to the transaction processor 14, as illustrated at arrow ‘E’, either granting authorization for the transaction or denying authorization.

At this point, the transaction will also include the authorization/denial from the issuer 16 and the transaction processor 14 communicates back to the acquirer 12 as illustrated by arrow ‘F’. Having received the transaction including authorization/denial from the issuer 16 the acquirer 12 then communicates the transaction back to the merchant 4, as illustrated at arrow ‘G’. At this point, the merchant 4 has received the authorization for the original transaction for the digital device data set and so the merchant 4 communicates the authorization to the user/cardholder 100, as illustrated by arrow ‘A’, thereby completing the transaction.

As discussed above, an overseas user/cardholder 2, particularly a non-EU resident, may purchase goods for which they wish to claim back the VAT paid on the goods, which is currently 20% in the UK. The process of the present disclosure allows the user to make such a tax reclaim by way of an electronic system which avoids the need to complete a paper-based tax refund application on the premises of the merchant 4 and provides a much more flexible and swift resolution to the application.

Electronic Tax Refund Scheme/Process

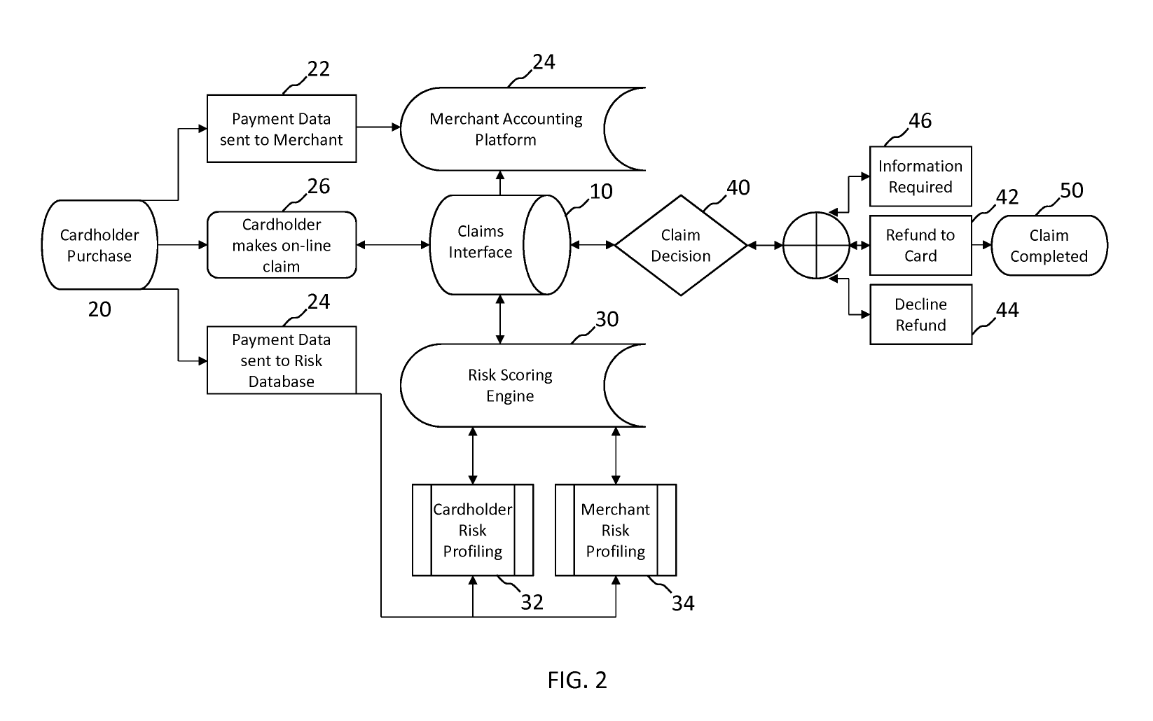

The process will now be described with reference to FIG. 2 in conjunction with FIG. 1.

A cardholder purchase occurs at step 20 in the manner of the payment transaction process described above with reference to FIG. 1. As part of the payment transaction process, payment data is transmitted to the merchant at step 22 which is then stored on an accounting platform 24 of the merchant 4 that handles payments processing as well as storing historic data of transactions including VAT rates for purchased goods. The accounting platform 24 includes a monitoring module for monitoring tax paid on purchases of goods/services. The accounting platform 24 also includes a communication module arranged to communicate with a claims interface processor for receiving a tax refund instruction therefrom. The accounting platform 24 also includes a payment module arranged to instruct a merchant to pay monies to a user/cardholder based on the tax refund instruction.

At this point, as shown at step 24, details of the payment transaction are also communicated to a tax refund processor 6, as indicated by the dashed arrow in FIG. 1, which stores the transaction details in an internal risk database. This data is then used in a subsequent application that a user/cardholder makes to reclaim the VAT made on the purchase.

The user/cardholder 2 creates at step 26 a VAT refund application on the claims interface 10 which includes suitable software to gather information from the user (relevant transaction, passport details, home country, age, occupation, as a few examples). As discussed, it is envisaged that the claims interface is a software application on a personal computing device of the user. Preferably, the claims interface 10 will be internet-based, accessible via a standard internet browser including a secure registration/login module, and will provide the facility to reclaim VAT on purchases retrospectively after the overseas visitor has left the UK, but within the claim term limit set by HMRC, which is currently 3 months. In essence, the claims interface provides an electronic link between the claimant (user/cardholder) 2, the tax authority (HMRC) 8 and the tax refund processor 6 (e.g. MasterCard®, Visa®). Beneficially, the claims interface 10 may have a direct feed of the transaction data from both the merchant 4 and the user/cardholder 2 that is held centrally in a suitable database structure by the tax refund processor 6.

The claims interface module 10 includes a registration module such that the cardholder can register their debit or credit card that they want to use in the electronic VAT refund process. This would permit a range of risk checks to be carried out on the consumers participating in the scheme but would also enable the scheme to be marketed effectively to drive its take-up amongst consumers.

The claims interface 10 then communicates with the tax refund processor 6 in order to get a decision on whether i) the tax refund is approved, ii) the tax refund is denied or iii) a decision is postponed pending further information. To this end, the tax refund processor 6 conducts a query of an internal risk scoring engine 30. The risk scoring engine 30 takes the transaction data from the claims interface and cross references this data with further data items from a cardholder risk profiling process 32 and a merchant risk profiling process 34. These processes will be described in more detail later under their corresponding headings. For present purposes, however, the risk scoring engine 30 returns a credit score value to the claims interface. Having received the risk scoring value that quantifies the aggregate risk of the transaction based on factors of the i) the transaction itself, ii) the user/cardholder, and iii) the merchant, the claims interface 10 communicates at step 40 with the tax authority 8 for decision to be made on the tax refund application. The risk scoring value may be a value on an appropriate numerical scale that allows suitable resolution for implementation of several predetermined thresholds to embody the decision making result.

Based on the risk scoring value communicated to it from the claims interface, the tax authority 8 makes a decision to i) approve the claim, ii) decline the claims or, iii) request more information as shown at steps 42, 44, and 46 respectively. Following this, the claims refund terminates at step 50 at which point the user/cardholder is able to logout of the claims tax refund application.

At step 42, if the decision is to refund the card, the user/cardholder would be notified that the claim application has been approved and a refund to the user/cardholder's card would be initiated. Here, claims interface 10 may notify the merchant accounting platform 24 that a refund is required. In response, the merchant 4 would trigger a refund transaction through the acquirer 12 which would take place with the approval of the merchant 4. The merchant 4 would also modify its internal accounts appropriately to reflect the change in VAT that was levied i.e. the merchant would ‘zero rate’ the transaction.

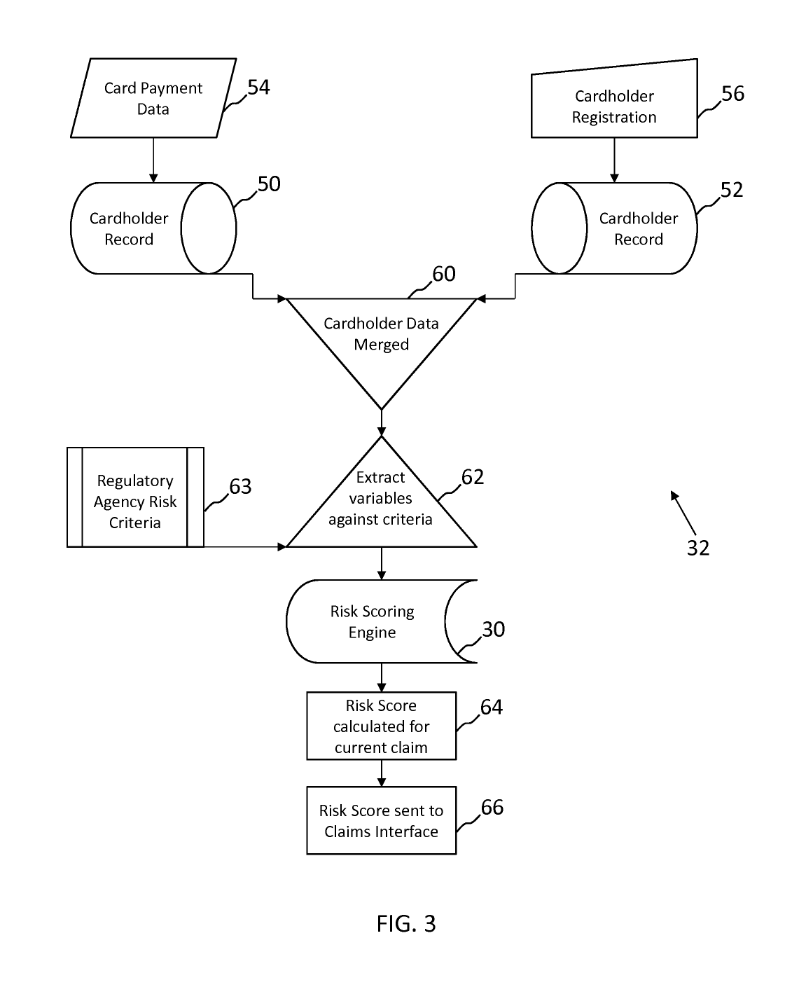

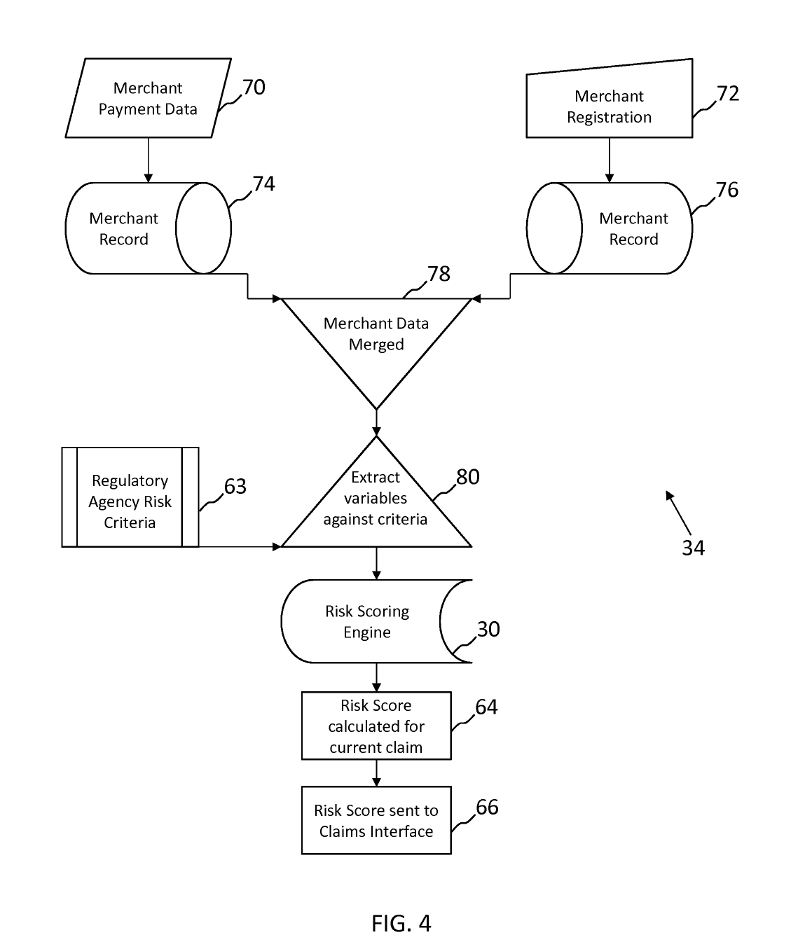

As has been mentioned above, the risk scoring engine 30 that is implemented by the tax refund processor 6 factors in a risk profiling process in respect of the user/cardholder 2 and also in respect of the merchant 4 in order to quantity the risk associated with refunding the tax of any particular transaction to the claims interface. This risk scoring process is carried out by the tax refund processor 6 effectively ‘on behalf’, of the tax authority 8 who is then able to give the final go ahead or otherwise to the tax refund. The risk profiling process in respect of the cardholder 2 and the merchant 4 will now be described in more detail with reference to FIGS. 3 and 4. Firstly, the cardholder risk profiling.

Cardholder Risk Profiling

Here the card holder risk profiling process 32 is explained in more detail with reference to FIG. 3. In general terms, the process 32 receives two sources of data 54,56 in respective cardholder records 50, 52. Firstly, data 54 is received from the payment transaction that the user/cardholder 2 has made in FIG. 1, as indicated by the dashed arrow. Secondly, cardholder registration data 56 is received by way of a registration activity by a user in order to be registered with the electronic VAT refund scheme. The user/cardholder 2 may achieve this through the use of the claims interface 10 or, alternatively, the tax refund handler 6 may provide the user/cardholder 2 with another way to register their card into the process.

It is envisaged that the payment data 54 will include, for example, details of the goods/services purchased; and category of product. The cardholder record 50 can then build up a picture of how the user/cardholder 2 uses their card: frequency of use; stores in which it is used and how often; countries in which it is used; categories of good purchased etc. From this, it will be appreciated that the tax refund processor 6 is able to monitor the usage and claim history of the consumer (user/cardholder/claimant) which helps to ‘de-risk’ the process against fraudulent claims. It enables the building of a profile of the consumer's usage of the tax refund scheme and also more generally benchmark this against their purchasing history outside of the tax refund scheme. This will enable the tax refund processor 6 to set parameters around individual cards for their usage in the tax refund scheme. For instance, the tax processor 6 may cooperate with the tax authority 8 to limit the amount of claims permissible in a given period, e.g. a maximum of four claims per annum. Similarly, it is possible to institute controls around the monetary value of the claim, e.g. limit & verify the eligible transaction claim to £2000 (approximately $3250 USD).

It is envisaged that the cardholder registration data 56 will include, for example, passport details and cardholder address. Other information may be included depending on the policy of the relevant tax authority, in this case HMRC.

The data 54,56 is merged into a single record at merging step 60 and then, at extraction step 62, a predetermined set of variables is extracted based on the merged set of cardholder data 60. The exact set of variables that are extracted at step 62 depend upon the criteria established by the tax authority 8 at a risk criteria process 63, as will be explained in further detail later.

Once the relevant set of risk profiling variables has been extracted at step 62, the criteria is passed to the risk scoring engine 30 as shown as the output from predetermined process step 32 in FIG. 2. As has been discussed, the risk scoring engine 30 then calculates a risk scoring value and returns this to the claims interface 10. It should be noted that these steps are indicated as steps 64 and 66 in FIG. 3 but are output elements from the risk scoring engine 30 in FIG. 2.

Risk-profiling cardholders enables the tax authority 8 (HMRC) to apply flexibility in setting the threshold for automating tax refunds or ‘reclaims’ based upon any developing patterns of risk. For instance, if a particular set of variables in the cardholder records was leading to above-benchmark levels of ‘rejected’ or ‘need more information’ decisions then the risk-weighting of those variables and potentially taking actions to preclude certain categories of cardholder from the scheme. Additionally it provides a way of quickly matching the claim to the cardholder. In addition, by seeking consent to the rules of the scheme from the cardholder, there is the opportunity to gain the cardholder's permissions to market to them.

Merchant Risk Profiling

The merchant risk profiling process 34 will now be explained in more detail with reference to FIG. 4. In a similar way to the cardholder risk profiling process in FIG. 2, the merchant risk profiling process 34 receives two sources of data 70, 72 into respective merchant records 74, 76.

Merchant payment data 70 is received via the payment transaction that the user/cardholder 2 has established in FIG. 1, as indicated by the dashed arrow. Further, merchant registration data 72 is received by way of a registration activity that may be undertaken by the merchant 4. It is preferred that the merchant 4 registers itself in the electronic tax refund scheme, although it may be possible for the scheme to operate effectively, albeit with certain imposed limitations, if the merchant 4 is not registered with the scheme. It is preferable for merchants to register so that they can be identified more quickly and accurately but also enforce the merchants 4 to sign-up to the rules of the scheme as set out by the tax authority 8 (HMRC). Similarly, it becomes possible to more quickly identify issues with excessive amounts of incomplete or ineligible claims from particular merchants.

It is envisaged that the merchant payment data 70 will include the merchant ID (or ‘MID’) and will also identify the sector in which the merchant 4 operates by way of a ‘Merchant Category Code’ (MCC). It is envisaged that the tax refund processor 6 would work with the tax authority 8 to define the MCCs that would be eligible to operate under the electronic tax refund scheme. For example, the MCC for grocery stores may be ineligible but that the MCC for clothing stores would be eligible, due to the VAT rating treatment of those goods categories. It should be noted that there will be MCCs that are more general in nature and may contain different goods that are both VAT-eligible and goods that are not. For example, the MCC for department stores may have a children's section, an adult clothing section and a food hall. In such circumstances, the tax refund processor 6 may work with the acquirer 12 and merchant 4 to establish separate MIDs for those sections in the store if they were not already set up in that way. As such, it would be possible to enroll only the adult clothing MID into the electronic tax refund in the example given.

Ultimately this would assist in efforts to increase risk-profiling of merchants which may lead to an improvement in compliance with the VAT refund. As with consumers, the tax refund processor would be able to add and report upon parameters of use of the scheme that the tax authority considered were of use in combatting fraud. For example, exception reporting around merchants with significant occurrences of fraudulent claims above the benchmark for their sector would be possible. Similarly, exception reporting could be made for average claim sizes by merchant sector and added to a merchant's claims history, further ensuring compliance with the scheme.

In the above context, the merchant registration data 72 may include details of the multiple MIDs if this is relevant to their operations.

The merchant data records 64,76 are merged at merging step 78 into a single data set. Then, at extraction step 80, a predetermined set of variables is extracted from merged data set 78 of the merchant data. The exact set of variables that are extracted is dependent on the criteria established by the tax authority 8 at a risk criteria process 63 as mentioned in connection with the cardholder risk filing process described above with reference to FIG. 2.

Following the extraction of the relevant risk profiling variables at step 80, the variables are passed to the risk scoring engine 30 as shown as the output from predetermined process step 32 in FIG. 2. As has been discussed, the risk scoring engine 30 then calculates a risk scoring value and returns this to the claims interface 10. It should be noted that these steps are indicated as steps 64 and 66 in FIG. 3 but are output elements from the risk scoring engine 30 in FIG. 2.

Risk Criteria Process

The risk criteria process 63 is a process that is implemented by the tax authority 8, for example HMRC in the UK, to establish a criteria set 100 that is relevant for the calculation of a risk scoring value by the tax refund processor 6. In overview, the criteria set includes inputs from three sources. Firstly, data 102 is sourced from regulatory policy that is determined should be applied to the electronic VAT refund scheme. From the overall policy data 102, steps are taken to define a set of eligible goods (step 104) and to define a set of eligible claimants (at step 106).

The list of eligible goods are based on public policy and may change over time. In general, however, eligible goods may be those that are deemed ‘low risk’ such that the purchase of such goods is desired to be promoted to overseas travellers. Such eligible goods may include clothing, artwork, and consumer electronics, for example. Jewelry may be excluded for risk reasons e.g. a higher propensity to not leave the country and of a higher value.

The list of eligible claimants relates to user/cardholders deemed to represent a low risk. So, for example, user/cardholders may be eligible if their income exceeds a certain predetermined threshold, or if their frequency of VAT claim-back does not exceed a certain threshold. Also, eligibility may be suggested by card usage being consistent with believing that the cardholder is returning to their host country, e.g., what they normally spend in the U.S, but there is a raft of European receipts, then they return to the U.S.

A second source of data 108 is sourced from card relationship criteria and, from this is established a list of financial products, at step 110 that are eligible to be used in the electronic tax refund scheme. For example, debit and credit cards may be considered to be eligible since the users of those cards have been the subject of a variety of checks and due diligence by the card issuers. Also, it may be desirable to mark ‘pre-paid’ cards as ineligible since there is little knowledge of the user carried through the use of such a product. A business credit card may also be identified as ineligible since there may already be a tax refund facility via the business.

At step 112, a set of licensing conditions are identified from the data 108 which identifies the regulatory conditions that card issuers must follow in order to validly issue cards to their users/cardholders, and payment processors such as MasterCard®, Visa® also set licensing conditions under which their members issue products.

Thirdly, additional registration data 114 is defined and this data may determine what data is required from the processes by which the user/cardholders and the merchants may register with the electronic tax refund scheme. From this data 114, steps 116 and 118, a set of registrant requirements is defined.

Registrant requirements is to be considered to be the data of the merchant or cardholder that the tax refund processor will require them to complete for them to be accepted as a registered user of the scheme, e.g. passport Number or Tax Number, address.

Reclaim requirements is to be considered the data that will be required to make a valid automatic tax refund application, e.g. declaration that the goods are for export and user is liable to punishment if not or perhaps that the person is not a temporary resident of the country where the goods are purchased, etc.

The three data sources are input into decision step 120 in which relevant criteria are selected appropriately and developed into the criteria set 100, which is output to the extraction step 62 in FIG. 32 and extraction step 80 in FIG. 4.

Exemplary Benefits

The electronic management of tax refunds in this way confers many benefits. Importantly, since the tax refund scheme operates through an existing cooperative network of card-issuing banks, acquirers, merchants and payment processors, there is increased assurance over the identity of the cardholder who is making the tax refund claim, and control over the use of the card. As such, where a card is used to purchase goods under the scheme and then is used subsequently to claim a refund of the purchase tax, there is established traceability of the individual using the card. This traceability acts as a significant deterrent to fraudulent claims from consumers and provides greater traceability and transparency than the paper-based schemes which, typically, only require passport details as the form of identification.

Since the processing of the purchase tax refunds is handled centrally by the tax recovery application supplier, it is possible to ‘charge-back’ claims that are subsequently proven to be fraudulent or non-compliant. Such a facility may be executed in parallel with existing ‘charge-back’ schemes that are operated by global financial services payments processors, such as MasterCard® and Visa®, and may enable reclamation of fraudulent transactions by taxation authorities.

The establishment of product categories enables risk management profiling to be integrated into the tax reclaim process.

Risk management is further provided by the fact that the tax recovery application supplier is acquainted with cardholders and may therefore be in possession of cardholder data which allows the risk of the cardholder with respect to the tax refund to be assessed. For example, the supplier may typically be able to broadly segment customer income based on the card product that they hold and moreover may be able to qualify the cardholders income level with card-issuing banks if income level is considered to be an important factor in the effective operation of the tax refund process.

Also, since the tax refund processor may also be central to the card issuing process, (for example the tax refund processor is preferably a payments authorisation and processing entity such as MasterCard® or Visa®) it is able to control eligibility of cardholder types to the tax refund scheme. For example, it may be considered necessary to limit eligibility of debit and credit card holders only and to excluded Prepaid and Commercial Products, the latter due to the fact that such cards may typically already be eligible to be used in a tax reclaim in a business setting.

A significant advantage of the ‘digital’ tax refund scheme is that the merchant is required to perform less administrative work compared with the current paper-based system since there is a reduction in paperwork that needs to be completed at the point of sale. Not only is this an operational burden for the merchant but it is usually considered difficult for the merchant to implement the process in a way that complies fully with the requirements of the tax authority. The ‘digital’ scheme as described above would remove the need for the merchant to create manual documents and would simply require the merchant to register with the scheme. The burden of providing the information is therefore shifted to the tax reclaim applicant that is backed-up by the information contained in the record of the financial transaction relating to the relevant purchase. It is also possible for a merchant not to be required to be registered for the scheme and the tax refund processor or ‘administrator’ could make use of information relating to the merchant that it already holds, together with acquiring banks to select merchants that meet a predetermined risk-profile as agreed with the tax authority.

Since the administrative burden on merchants is reduced, it is envisaged that the numbers of merchants willing to participate in the tax refund scheme will increase, as will the geographical distribution of the network of merchants that is likely to encourage retail shopping by international consumers. In turn, this is likely to lead to a wider range of goods that are eligible for vat refunds and may increase market competition for those goods that will benefit the consumer.

It is envisaged that the electronic tax refund process may operate in parallel with an established ‘paper-based’ equivalent scheme pending increased take up of the electronic scheme to a stage that there is justification for disbanding the paper-based counterpart.

What is claimed is:

1. A claims interface processor for an electronic device, comprising:
a tax refund application for allowing a user/cardholder to apply for a tax refund based on prior product purchases;
a communication module arranged to send the tax refund application to a tax refund processor and receive a tax refund approval or rejection, the tax refund approval or rejection based on a risk score relating to the tax refund application; wherein
the communication module is also arranged to send a tax refund instruction to an acquirer in response to receiving the tax refund approval.

2. The claims interface processor of claim 1 wherein the communication module is arranged to receive the risk score from the tax refund processor in response to sending the tax refund application and wherein the communication module is further arranged to send the risk score to a tax refund authority in response to receiving the risk score and receive the approval or rejection from the tax refund authority.

3. The claims interface processor of claim 1 comprising a registration module for allowing a user/cardholder to register a card for making product purchases.

4. The claims interface processor of claim 1 being internet based for communicating with the tax refund processor and the tax authority remotely.

5. The claims interface processor of claim 1 further comprising a secure login module arranged to allow a user/cardholder to login in securely.

6. The claims interface processor of claim 1 arranged to provide a notification to the user/cardholder that the tax refund application has been approved or declined in response to receiving the tax refund approval or rejection.

7. A tax refund processor comprising:
risk scoring engine arranged to monitor a transaction made by a user/cardholder and to provide a risk score associated with refunding a tax of the transaction; and
an interface module arranged to receive a tax refund application from a claims interface processor of claim 1 and output the risk score in response.

8. The tax refund processor of claim 7 wherein the risk score is returned to the claims interface processor.

9. The tax refund processor of claim 7 wherein the risk score is determined based on a risk associated with the user/cardholder and a risk associated with a merchant involved in the transaction.

10. The tax refund processor of claim 9 wherein the risk associated with the user/cardholder is based on data relating to payment transactions made by the user/cardholder and data relating to user/cardholder registration.

11. The tax refund processor of claim 10 wherein the data relating to the payment transactions includes at least one of frequency of use, stores, country of use, number of previous claims, and category of good/services purchased.

12. The tax refund processor of claim 10 wherein the data relating to user/cardholder registration includes at least one of passport details, cardholder address, and card details.

13. The tax refund processor of claim 9 wherein the risk associated with a merchant involved in the transaction is based on merchant payment data recorded by the tax refund processor and merchant registration data provided by a merchant upon registration.

14. The tax refund processor of claim 13 wherein the merchant payment data includes at least one of a Merchant Identification Number (MID) and a Merchant Category Code (MCC).

15. A merchant accounting platform comprising:
a monitoring module for monitoring tax paid on purchases of goods/services;
a communication module arranged to communicate with a claims interface processor of claim 1 for receiving the tax refund instruction; and
a payment module arranged to instruct a merchant to pay monies to a user/cardholder based on the tax refund instruction.

16. The merchant of claim 15 further comprising a registration interface for registering details relating to a merchant involved in the transaction.
